(19) United States
(12) Patent Application Publication
(10) Pub. No.: US 2026/0045694 A1
(43) Pub. Date: Feb. 12, 2026

(54) METAL FRAME ANTENNA

(71) Applicant: QUALCOMM Incorporated, San Diego, CA (US)

(72) Inventors: Cong LI, Shanghai (CN); Min HUI, Shanghai (CN); Huajun JIANG, Shanghai (CN); Wei TANG, Shanghai (CN)

(21) Appl. No.: 19/101,435

(22) PCT Filed: Sep. 23, 2022
(86) PCT No.: PCT/CN2022/120810

§ 371 Date: Feb. 5, 2025

(51) Int. Cl. H01Q 5/328; H01Q 1/24

(52) U.S. Cl. CPC H01Q 5/328; H01Q 1/241

(57) ABSTRACT

A signal transfer method includes: transferring a first signal in a first frequency band between a metal frame member and a first front-end circuit, the metal frame member extending along a portion of a periphery of an apparatus; and transferring a second signal in a second frequency band between the metal frame member and a second front-end circuit by reactively coupling the metal frame member and a coupling element that is electrically connected to the second front-end circuit.

### BACKGROUND

Wireless communication devices are increasingly popular and increasingly complex. For example, mobile telecommunication devices have progressed from simple phones, to smart phones with multiple communication capabilities (e.g., multiple cellular communication protocols, Wi-Fi, BLUETOOTH® and other short-range communication protocols), supercomputing processors, cameras, etc. Wireless communication devices have antennas to support various functionality such as communication over a range of frequencies, reception of Global Navigation Satellite System (GNSS) signals, also called Satellite Positioning Signals (SPS signals), etc.

With several antennas disposed in a single wireless communication device, coupling between antennas may degrade performance. For example, power in a transmitted communication signal may be received and dissipated by another antenna in the device, e.g., an antenna for receiving GNSS signals, an antenna for receiving and transmitting other communication signals, etc. As another example, power may flow between antenna systems in close proximity to each other, e.g., if both of the antenna systems use a shared conductor for their respective radiators.

### SUMMARY

An example apparatus includes: a metal frame member extending along a portion of a periphery of the apparatus; a first front-end circuit coupled to the metal frame member and configured to at least one of transmit a first signal in a first frequency band to the metal frame member or receive the first signal from the metal frame member; a first ground connector coupled to the metal frame member, and physically and electrically connected to a first ground conductor; a coupling element that is spaced apart from the metal frame member and is configured and disposed relative to the metal frame member to reactively couple to the metal frame member; a second front-end circuit electrically connected to the coupling element and configured to at least one of transmit a second signal in a second frequency band to the coupling element or receive the second signal from the coupling element; and a second ground connector electrically connected to the coupling element and physically and electrically connected to a second ground conductor.

An example signal transfer method includes: transferring a first signal in a first frequency band between a metal frame member and a first front-end circuit, the metal frame member extending along a portion of a periphery of an apparatus; and transferring a second signal in a second frequency band between the metal frame member and a second front-end circuit by reactively coupling the metal frame member and a coupling element that is electrically connected to the second front-end circuit.

Another example apparatus includes: means for transferring a first signal in a first frequency band between a metal frame member and a first front-end circuit, the metal frame member extending along a portion of a periphery of the apparatus; and means for transferring a second signal in a second frequency band between the metal frame member and a second front-end circuit by reactively coupling the metal frame member and a coupling element that is electrically connected to the second front-end circuit.

### BRIEF DESCRIPTION OF THE DRAWINGS

FIG. 1 is a diagram of a communication system.

FIG. 2 is an exploded perspective view of simplified components of a mobile device shown in FIG. 1.

FIG. 3 is a plan view of an apparatus including antenna systems.

FIG. 4 is a simplified circuit diagram of an example of metal frame antenna systems of an apparatus with one of the antenna systems being capacitively coupled to a metal frame.

FIG. 5 is a simplified circuit diagram of another example of metal frame antenna systems of an apparatus with one of the antenna systems being capacitively coupled to a metal frame.

FIG. 6 is a simplified circuit diagram of another example of metal frame antenna systems of an apparatus with two of the antenna systems being capacitively coupled to a metal frame.

FIG. 7 is an example implementation of the apparatus shown in FIG. 4.

FIG. 8 is an example implementation of the apparatus shown in FIG. 5.

FIG. 9 is an example implementation of the apparatus shown in FIG. 6.

FIG. 10 is an example of the apparatus shown in FIG. 4, showing a signal processing module and a matching circuit of each of two antenna systems.

FIG. 11 is a simplified circuit diagram of an example of two metal frame antenna systems of an apparatus with both of the antenna systems being capacitively coupled to a metal frame.

FIG. 12 is a block diagram of a signal transfer method.

### DETAILED DESCRIPTION

Techniques are discussed herein for signal transfer with antennas using a metal frame radiator. For example, a portion of a metal frame of an apparatus (e.g., a smartphone, a tablet computer, etc.) is used as a radiator (for signal reception and/or signal transmission) by multiple antenna systems. The antenna systems may operate over different frequency bands. A front-end circuit of at least one of the antenna systems is reactively coupled to the metal frame without an electrical conductor physically connected to the metal frame and the front-end circuit. For example, the front-end circuit may be electrically connected to a coupling element that is configured and disposed to reactively (e.g., capacitively) couple to the metal frame. In an implementation, one or more other antenna systems may be electrically connected to the metal frame. In an implementation, a first antenna system may be reactively coupled to a metal frame along a portion of a length of the metal frame, and a second antenna system electrically connected to the metal frame at one or more points in the portion of the length of the metal frame. In implementation, multiple antenna systems may have respective front-end circuits that are reactively coupled to the metal frame. Other configurations, however, may be used.

Items and/or techniques described herein may provide one or more of the following capabilities, as well as other capabilities not mentioned. Multiple antenna systems may be provided in an apparatus more compactly than with prior techniques. Multiple antenna systems may operate over different frequency bands using a common portion of a metal frame as a radiator, and with better isolation than with prior techniques. Multiple antenna systems may provide wider bandwidth than with prior techniques. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

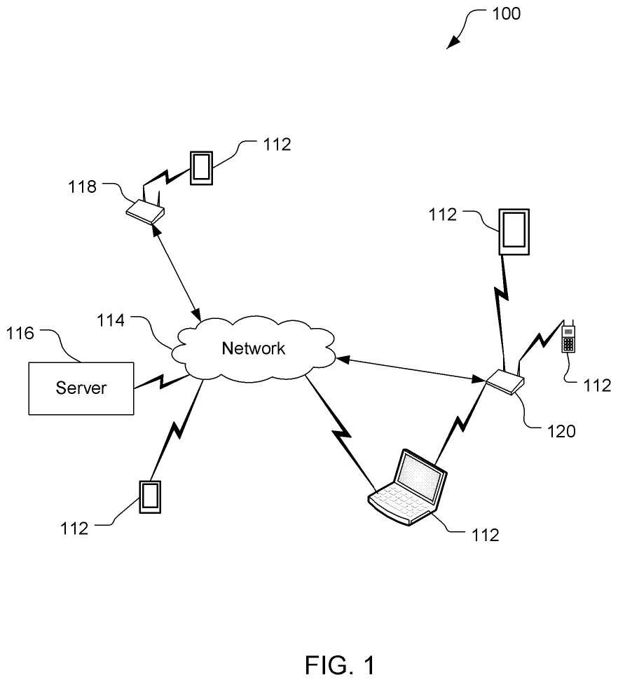

Referring to FIG. 1, a communication system 100 includes mobile devices 112, a network 114, a server 116, and access points (APs) 118, 120. The communication system 100 is a wireless communication system in that components of the communication system 100 can communicate with one another (at least some times) using wireless connections directly or indirectly, e.g., via the network 114 and/or one or more of the access points 118, 120 (and/or one or more other devices not shown, such as one or more base transceiver stations). For indirect communications, the communications may be altered during transmission from one entity to another, e.g., to alter header information of data packets, to change format, etc. The mobile devices 112 shown are mobile wireless communication devices (although they may communicate wirelessly and via wired connections) including mobile phones (including smartphones), a laptop computer, and a tablet computer. Still other mobile devices may be used, whether currently existing or developed in the future. Further, other wireless devices (whether mobile or not) may be implemented within the communication system 100 and may communicate with each other and/or with the mobile devices 112, network 114, server 116, and/or APs 118, 120. For example, such other devices may include internet of thing (IoT) devices, medical devices, home entertainment and/or automation devices, automotive devices, etc. The mobile devices 112 or other devices may be configured to communicate in different networks and/or for different purposes (e.g., 5G, Wi-Fi communication, multiple frequencies of Wi-Fi communication, satellite communication and/or positioning, one or more types of cellular communications (e.g., GSM (Global System for Mobiles), CDMA (Code Division Multiple Access), LTE (Long-Term Evolution), etc.), Bluetooth® communication, etc.).

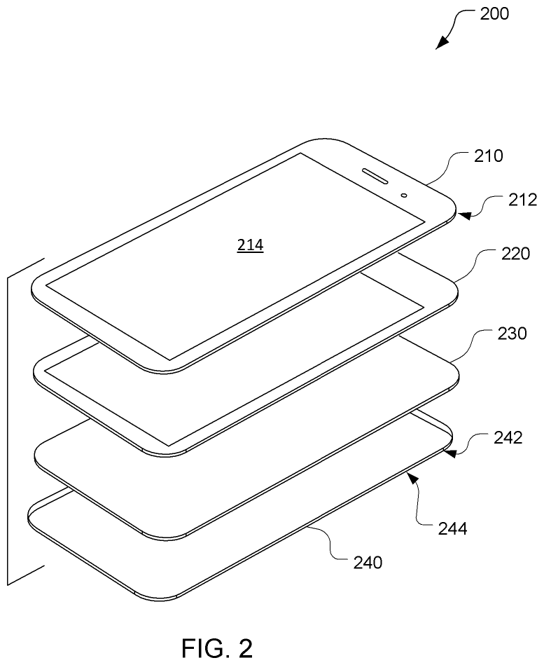

Referring to FIG. 2, a mobile device 200, which is an example of one of the mobile devices 112 shown in FIG. 1, includes a top cover 210, a display layer 220, a printed circuit board (PCB) layer 230, and a bottom cover 240. The mobile device 200 as shown may be a smartphone or a tablet computer but embodiments described herein are not limited to such devices (for example, in other implementations of concepts described herein, a device may be a router or customer premises equipment (CPE)). The top cover 210 includes a screen 214. The bottom cover 240 has a bottom surface 244. Sides 212, 242 of the top cover 210 and the bottom cover 240 provide an edge surface. The top cover 210 and the bottom cover 240 comprise a housing that retains the display layer 220, the PCB layer 230, and other components of the mobile device 200 that may or may not be on the PCB layer 230. For example, the housing may retain (e.g., hold, contain) or be integrated with antenna systems, front-end circuits, an intermediate-frequency (IF) circuit, and a processor discussed below. The housing may be substantially rectangular, having two sets of parallel edges in the illustrated embodiment, and may be configured to bend or fold. In this example, the housing has rounded corners, although the housing may be substantially rectangular with other shapes of corners, e.g., straight-angled (e.g., 45°) corners, 90°, other non-straight corners, etc. Further, the size and/or shape of the PCB layer 230 may not be commensurate with the size and/or shape of either of the top or bottom covers or otherwise with a perimeter of the device. For example, the PCB layer 230 may have a cutout to accept a battery. Further, the PCB layer 230 may include sandwiched boards and/or a PCB daughter board. Daughter boards may be chosen to facilitate a design and/or manufacturing process, e.g., to reinforce a functional separation or to better utilize a space in the housing. Embodiments of the PCB layer 230 other than those illustrated may be implemented.

The limited space available in a UE (e.g., a smartphone, tablet computer, etc.) presents antenna design challenges. For example, with 10 or more antennas for LTE and sub-6 GHz band in a mobile phone, there may be no additional space available for another antenna. Because antenna frequency bandwidth varies with antenna size, with small antennas typically having narrow bandwidths, designing a stand-alone antenna to cover a wide frequency bandwidth is challenging. Further, mechanical stability of a UE (e.g., a mobile phone) may be challenging, e.g., because non-conductive (e.g., plastic) breaks in a metal frame of the UE may be needed to separate antennas, but too many breaks (e.g., to separate a multitude of antennas) may weaken stability of the frame and may result in thermal issues due to an inability to dissipate heat.

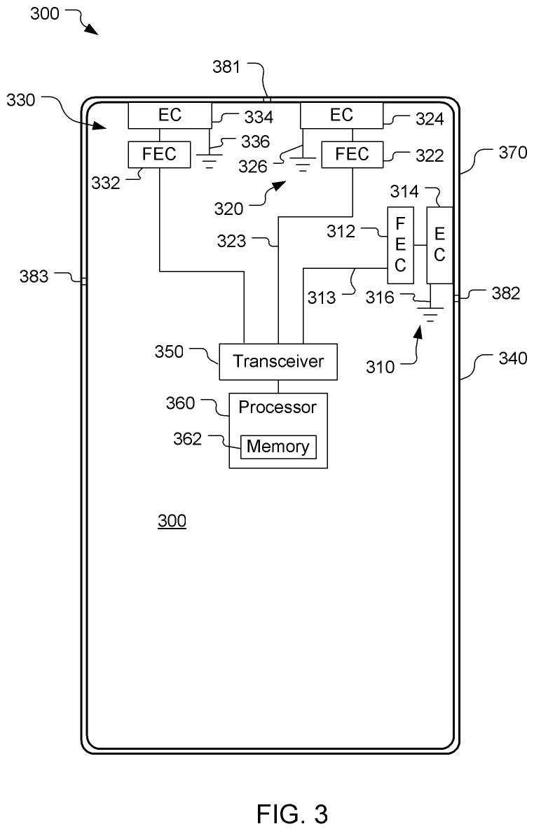

Referring also to FIG. 3, an apparatus 300 includes antenna systems 310, 320, 330. The apparatus 300 may be an example of the mobile device 200. This is an example, and other types of apparatus may be used and/or other quantities of antennas may be provided in the apparatus 300. For example, the antenna system 330 may be omitted. As another example, some present smartphones include eight (8) or more antennas, e.g., 11 or more antennas. Each of the antenna systems 310, 320, 330 include a front-end circuit (FEC) 312, 322, 332, an energy coupler (EC) 314, 324, 334, and a ground connector 316, 326, 336, respectively. In the example shown, the FEC 312, the EC 314, and the ground connector 316 of the antenna system 310 are disposed along or near a right edge of the apparatus 300, and the FECs 322, 332, the ECs 324, 334, and the ground connectors 326, 336 of the antenna systems 320, 330 are disposed along or near a top edge of the apparatus 300. One or more of the antenna systems 310, 320, 30 may be disposed elsewhere relative to the apparatus 300. At least the antenna systems 310, 320 are configured to use a portion of a metal frame 340 (e.g., of stamped metal) as a transducer to transduce between wired radio frequency (RF) signals and wireless RF signals. The energy couplers 314, 324, 334 are configured to convey energy to and/or from antenna elements of the antenna systems 310, 320, 330, respectively. The antenna elements may be referred to as radiating elements even though antenna elements are reciprocal, being capable of radiating wireless signals and receiving wireless signals. The front-end circuits 312, 322, 332 (also called radio frequency (RF) circuits) are coupled to a transceiver 350, which is coupled to a processor 360 including a memory 362. The memory 362 may be a non-transitory, processor-readable storage medium that includes software with processor-readable instructions that are configured to cause the processor 360 to perform functions (e.g., possibly after compiling the instructions). The processor 360 may be implemented as a modem or a portion thereof. One or more of the antenna systems 310, 320, 330 may comprise a wire inverted-F antenna (WIFA).

The front-end circuits 312, 322, 332 may be configured to provide one or more signals to be radiated by antenna elements of the antenna systems 310, 320, 330 and/or to receive and process one or more signals that are received by, and provided to the front-end circuits 312, 322, 332 from respective antenna elements of the antenna systems 310, 320, 330. One or more of the front-end circuits 312, 322, 332 may include a respective matching circuit to facilitate transfer of signals from the FECs 312, 322, 332 to the ECs 314, 324, 334 and from the ECs 314, 324, 334 to the FECs 312, 322, 332. The front-end circuits 312, 322, 332 may be configured to process (e.g., amplify, route, filter, etc.) RF signals received from the transceiver 350 or antenna elements of the antenna systems 310, 320, 330, for example without significantly adjusting a frequency thereof. In such examples, the transceiver 350 may be configured to convert a frequency of signals between baseband and RF (e.g., a frequency for wireless transmission or reception) in a direct conversion or heterodyne architecture.

The antenna systems 310, 320, 330 may be configured to operate at various frequencies. In some examples, the antenna systems 310, 320, 330 are configured for operation with sub-6 GHz (or sub-7 GHz) frequencies, for example in the range of 1.8 GHz-5 GHz. The front-end circuits 312, 322, 332 may be configured in some examples to convert received IF signals from the transceiver 350 to RF (Radio Frequency) signals (amplifying with a power amplifier and/or phase shifting signals, for example when coupled to an antenna array, as appropriate), and provide the RF signals to the antenna systems 310, 320, 330 for radiation. Similarly, the front-end circuits 312, 322, 332 may be configured to convert RF signals received by the antenna systems 310, 320, 330 to IF signals (e.g., using a low-noise amplifier and a mixer) and to send the IF signals to the transceiver 350. The transceiver 350 may be configured in these examples to convert IF signals received from the front-end circuits 312, 322, 332 to baseband signals and to provide the baseband signals to the processor 360. The transceiver 350 may be configured to convert baseband signals provided by the processor 360 to IF signals, and to provide the IF signals to the front-end circuits 312, 322, 332. The processor 360 is communicatively coupled to the transceiver 350, which is communicatively coupled to the front-end circuits 312, 322, 332, which are communicatively coupled to the ECs 314, 324, 334, which are communicatively coupled to antenna elements of the antenna systems 310, 320, 330.

The antenna system 310 and the antenna system 320 may both use a portion 370 of the metal frame 340 between breaks 381, 382 (e.g., an insulator such as plastic). In this way, space may be conserved for providing the antenna systems 310, 320. The antenna systems 310, 320 may operate over different (e.g., non-overlapping or partially overlapping) frequency ranges (e.g., different frequency bands), e.g., each corresponding to a standardized communication frequency band (e.g., LTE band, 5G band, WiFi band, Bluetooth® band, etc.) or standardized positioning frequency band (e.g., a standardized positioning reference signal band (which may be a standardized communication frequency band) or a standardized satellite positioning system band such as a GPS band, a GNSS band, a Beidou band, etc.). For example, the frequency band of the antenna system 310 may be lower than the frequency band of the antenna system 320. In an example implementation, the antenna system 310 may be configured to operate in a low band (e.g., B71, B12, B28, B20, B5, B8, etc. ; Japan band B11, B21, B32) and the antenna system 320 may be configured to operate in GNSS frequencies (e.g., L1/L2/L5). In another example implementation, the antenna system 310 may be configured to operate in a medium-high band (e.g., B1, B2, B3, B7, B40, B41, etc.) and the antenna system 320 may be configured to operate in sub-6 GHz frequencies (e.g., N77/N78/N79). In another example implementation, the antenna system 310 may be configured to operate in a low-medium-high band (e.g., B1, B2, B3, B5, B7, B8, B12, B20, B28, B40, B41, etc.), the antenna system 320 may be configured to operate in GNSS frequencies (e.g., L1/L2/L5), and the antenna system 330 may be configured to operate in sub-6 GHz frequencies (e.g., N77/N78/N79). The operational frequency band of the antenna system 310 may be close to, e.g., within 1.5 GHz of, the operational frequency band of the antenna system 320. The antenna system 330 may use a portion of the metal frame 340 between the break 381 and a break 383 as an antenna element for transducing RF signals.

One or more of the energy couplers 314, 324 may be configured to reduce coupling between the FEC 312 and the FEC 322. For example, as discussed further below, the energy coupler 324 may include a conductive coupling element that is configured and disposed to be tightly coupled to the portion 370 of the metal frame 340. The coupling element may, for example, be reactively coupled to the metal frame 340, e.g., being a conductive plate that is configured (e.g, being longer than 0.1 wavelengths) and disposed (e.g., less than 0.01 wavelengths) from the portion 370 of the metal frame 340 to capacitively couple to the metal frame 340. The FECs 312, 322 may be independently coupled to the transceiver 350 and the ground connectors 316, 326 may be independently physically and electrically connected to respective ground planes (by respective electrically-conductive lines) or respective portions of a common ground plane. Thus, lines 313, 323 connecting the FECs 312, 322 to the transceiver 350 are not electrically coupled to each other, and the ground connectors 316, 326 are not electrically coupled to each other except through a common ground plane (if the ground connectors 316, 326 are connected to a common ground plane). The antenna systems 310, 320 (and possibly 330) may be compact, using the same portion of the metal frame 340 for the antenna systems 310, 320. The antenna systems 310, 320 may provide a wide bandwidth, e.g., a bandwidth that is four to five times larger than previous antenna systems. The antenna systems 310, 320 may be easy to tune, e.g., due to having independent connections to FECs (including independent matching circuits) and ground. The antenna systems 310, 320 may provide flexibility as to location of the antenna systems 310, 320 in an apparatus (e.g., a UE such as a smartphone or tablet computer). The antenna systems 310, 320 may provide wide bandwidth of operation and/or operation in a variety of frequency ranges.

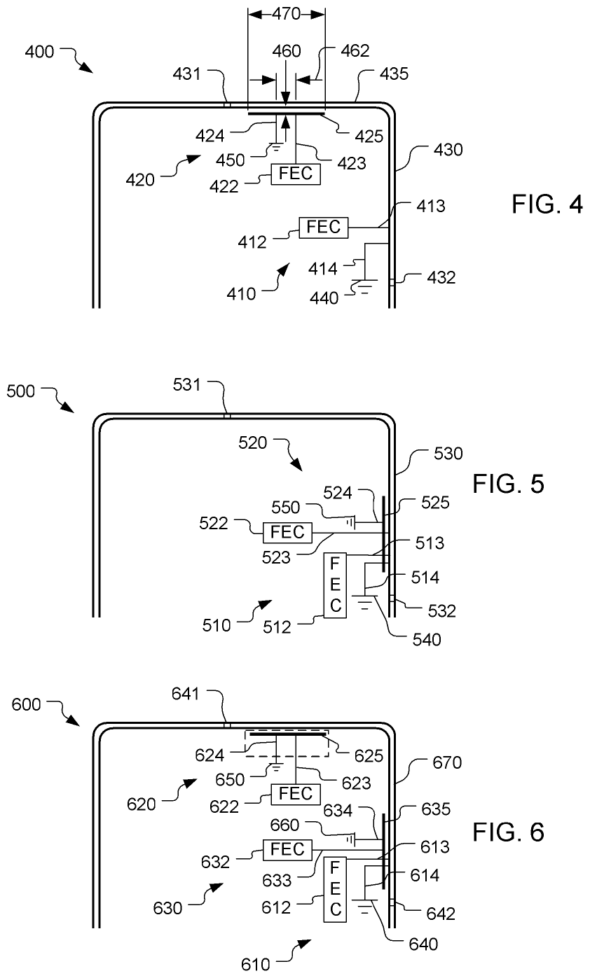

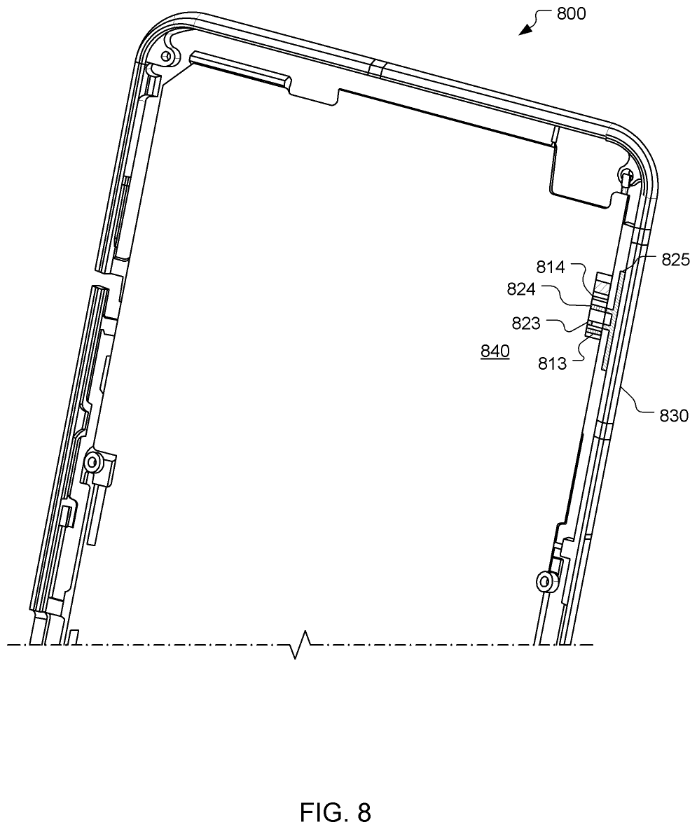

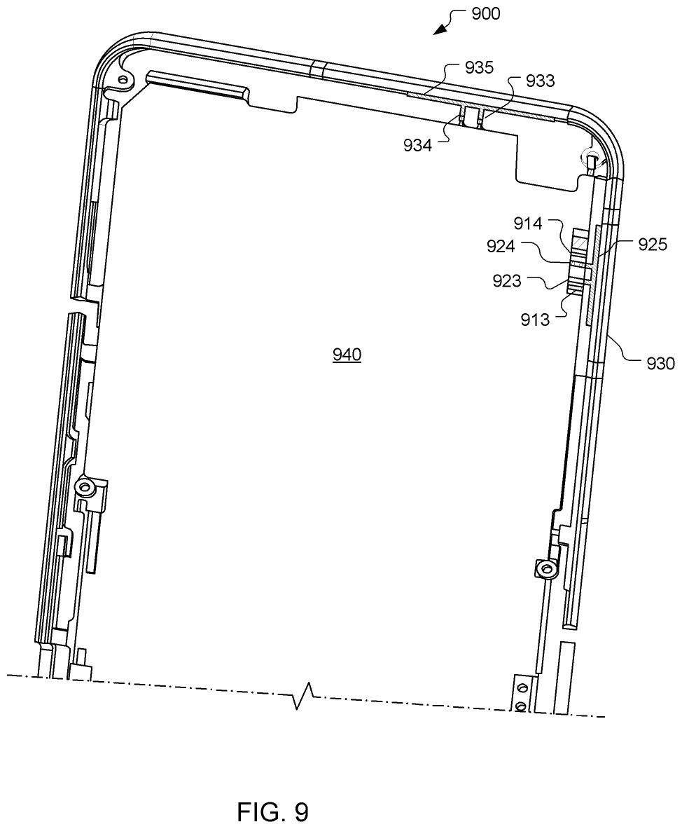

Numerous implementation examples of the antenna systems 310, 320, 330 are possible. Different implementations may be used depending, for example, on one or more desired performance characteristics and/or one or more design constraints (e.g., one or more antenna system locations). For example, the energy coupler 314 of the antenna system 310 may electrically couple the portion 370 of the metal frame 340 to the FEC 312 and to the ground connector 316, and the energy coupler 324 may reactively (e.g., capacitively) couple to the portion 370 of the metal frame 340, and be electrically connected to the FEC 322 and the ground connector 326, with the energy couplers 314, 324 coupling to different portions of the portion 370 of the metal frame 340 (here, along different edges of the apparatus 300 (e.g., see FIG. 4 where the portion 435 of the metal frame 430 used by the antennas 410, 420, extends along side and top edges of an apparatus 400)). As another example, such energy couplers may couple to the same portion of the portion 370 of the metal frame 340 (e.g., see FIGS. 5 and 8). As another example, multiple energy couplers may reactively couple to the portion 370 of the metal frame 340, e.g., along different edges of an apparatus, e.g., with one such energy coupler coupling to the same portion of the metal frame 340 as the energy coupler 314 (e.g., see FIGS. 6 and 9). As another example, the energy coupler 314 may reactively couple to the portion 370 of the metal frame.

Referring also to FIG. 4, a wireless signal transfer apparatus 400 (e.g., a UE), a portion of which is shown in FIG. 4, includes antenna systems 410, 420, that are examples of the antenna systems 310, 320. The antenna systems 410, 420 each use a portion 435 of a metal frame 430 of the apparatus 400 between breaks 431, 432 (e.g., insulators) in the metal frame 430. The antenna system 410 includes an FEC 412 electrically connected to the portion 435 of the metal frame 430 by an electrical conductor, here an electrically-conductive line 413, and a ground connector 414 electrically connected to the portion 435 of the metal frame 430 and to a ground conductor 440 (e.g., a PCB ground plane). The conductive line 413 (and optionally the ground connector 414) may comprise components of an energy coupler (e.g., an implementation of the energy coupler 314). The antenna system 420 includes an FEC 422 electrically connected to a coupling element 425 by an electrical conductor (here a conductive line 423), and a ground connector 424 electrically connected to the coupling element 425 and to a ground conductor 450 (e.g., the ground conductor 440 or another ground). The conductive line 423, optionally the ground connector 424, and the coupling element 425 may comprise components of an energy coupler (e.g., an implementation of the energy coupler 324).

The coupling element 425 is configured and disposed to reactively couple to the metal frame 430. In this example, the coupling element 425 is a conductive plate that is sized and disposed relative to the metal frame 430 to capacitively couple to the metal frame 430. For example, the coupling element 425 may be made of stamped metal. The coupling element 425 may be displaced from the metal frame 430 by enough distance to provide at least some isolation between the FEC 422 and the FEC 412, and disposed close enough to the metal frame 430 to provide capacitive coupling with the metal frame 430. For example, the coupling element 425 may be displaced from the metal frame by a distance 460 that is less than about 0.01 wavelengths of a center frequency configured to be processed by the FEC 422. The distance 460 may be, for example, about 1/300 of the wavelength of the center frequency. For example, for a frequency of about 2 GHz, with a corresponding wavelength of about 150 mm, the distance 460 may be about 0.5 mm or less. The coupling element 425 may have a length 470 to facilitate coupling of energy at the frequency of operation of the FEC 422 to/from the metal frame 430. For example, the length 470 may be between about 0.1 wavelengths and about 0.2 wavelengths of the center frequency of the FEC 422. For a center frequency of about 2 GHz, the length 470 may be about 22.5 mm. The conductive line 423 and the ground conductor 424 may be separated by a distance 462 of about 0.01-0.02 wavelengths, e.g., between about 2 mm and about 3 mm for a frequency of about 2 GHz. The distance 462 may vary with the length 470, with the distance 462 being larger corresponding to a longer length 470.

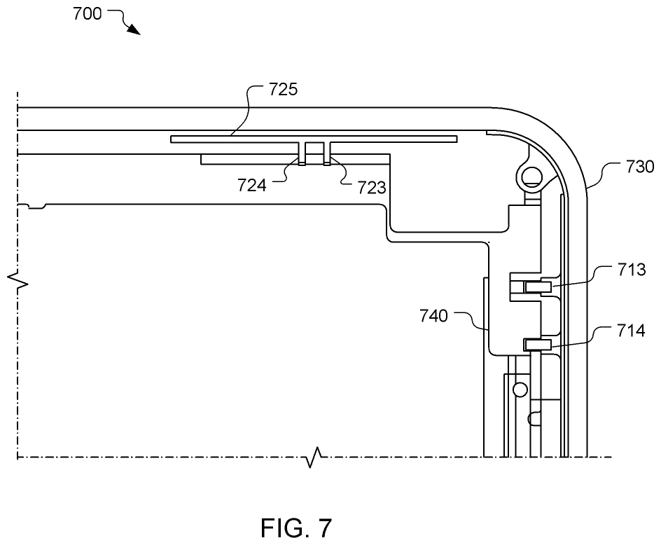

Referring also to FIG. 7, a portion of a wireless signal transfer apparatus 700 is an example implementation of the wireless signal transfer apparatus 400. The apparatus 700 includes a metal frame 730, a conductive line 723, a ground connector 724, and an coupling element 725 as parts of an antenna system (as an implementation of the antenna system 420), and a conductive line 713 and a ground connector 714 as parts of another antenna system (as an implementation of the antenna system 410). The conductive line 713 electrically connects the metal frame 730 to a front-end circuit (not shown), and the ground connector 714 electrically connects the metal frame 730 to a ground conductor 740 (which may be called a ground plane). The conductive line 723 electrically connects the coupling element 725 to a front-end circuit (not shown), and the ground connector 724 electrically connects the coupling element 725 to a ground plane, in this example, the ground conductor 740. The coupling element 725 may be, as in this example, disposed and configured to capacitively couple to the metal frame 730.

Referring also to FIG. 5, a wireless signal transfer apparatus 500 (e.g., a UE), a portion of which is shown in FIG. 5, includes antenna systems 510, 520, that are examples of the antenna systems 310, 320. The antenna systems 510, 520 each couple to a same portion of a metal frame 530 of the apparatus 500 between breaks 531, 532 (e.g., insulators) in the metal frame 530, although the antenna systems may couple to different amounts of the metal frame 530. The antenna system 510 includes an FEC 512 electrically connected to the metal frame 530 by a conductive line 513, and a ground connector 514 electrically connected to the metal frame 530 and to a ground conductor 540 (e.g., a PCB ground plane). The antenna system 520 includes an FEC 522 electrically connected to an coupling element 525 by a conductive line 523, and a ground connector 524 electrically connected to the coupling element 525 and to a ground conductor 550 (e.g., the ground conductor 540 or another ground). The conductive line 513 (and optionally the ground connector 514) may comprise components of an energy coupler (e.g., an implementation of the energy coupler 314). The conductive line 523, optionally the ground connector 524, and the coupling element 525 may comprise components of an energy coupler (e.g., an implementation of the energy coupler 324).

Referring also to FIG. 8, a portion of a wireless signal transfer apparatus 800 is an example implementation of the wireless signal transfer apparatus 400. The apparatus 800 includes a metal frame 830, a conductive line 823, a ground connector 824, and an coupling element 825 as parts of an antenna system (as an implementation of the antenna system 520), and a conductive line 813 and a ground connector 814 as parts of another antenna system (as an implementation of the antenna system 510). The conductive line 813 electrically connects the metal frame 830 to a front-end circuit (not shown), and the ground connector 814 electrically connects the metal frame 830 to a ground conductor 840. The conductive line 823 electrically connects the coupling element 825 to a front-end circuit (not shown), and the ground connector 824 electrically connects the coupling element 825 to a ground plane, in this example, the ground conductor 840. The coupling element 825 may be, as in this example, disposed and configured to capacitively couple to the metal frame 830.

Referring also to FIG. 6, a wireless signal transfer apparatus 600 (e.g., a UE), a portion of which is shown in FIG. 6, includes antenna systems 610, 620, 630 that are examples of the antenna systems 310, 320. The antenna systems 610, 620, 630 each couple to a same portion of a metal frame 670 of the apparatus 600 between breaks 641, 642 (e.g., insulators) in the metal frame 670, although the antenna systems may couple to different amounts of the metal frame 670. The antenna system 610 includes an FEC 612 electrically connected to the metal frame 670 by a conductive line 613, and a ground connector 614 electrically connected to the metal frame 670 and to a ground conductor 640 (e.g., a PCB ground plane). The antenna system 620 includes an FEC 622 electrically connected to an coupling element 625 by a conductive line 623, and a ground connector 624 electrically connected to the coupling element 625 and to a ground conductor 650 (e.g., the ground conductor 640 or another ground). The antenna system 630 includes an FEC 632 electrically connected to a coupling element 635 by a conductive line 633, and a ground connector 634 electrically connected to the coupling element 635 and to a ground conductor 660 (e.g., the ground conductor 640 or another ground). The coupling element 635, e.g., similar to the coupling element 625, is configured and disposed to reactively couple to the metal frame 670. The conductive line 613 (and optionally the ground connector 614) may comprise components of an energy coupler (e.g., an implementation of the energy coupler 314). The conductive line 623, optionally the ground connector 624, and the coupling element 625 may comprise components of an energy coupler (e.g., an implementation of the energy coupler 324). The conductive line 633, optionally the ground connector 634, and the coupling element 635 may comprise components of an energy coupler (e.g., an implementation of the energy coupler 324).

Referring also to FIG. 9, a portion of a wireless signal transfer apparatus 900 is an example implementation of the wireless signal transfer apparatus 600. The apparatus 900 includes a metal frame 930, a conductive line 923, a ground connector 924, and an coupling element 925 as parts of an antenna system (as an implementation of the antenna system 620), a conductive line 913 and a ground connector 914 as parts of another antenna system (as an implementation of the antenna system 610), and a conductive line 933, a ground connector 934, and an coupling element 935 as parts of another antenna system (as an implementation of the antenna system 630). The conductive line 913 electrically connects the metal frame 930 to a front-end circuit (not shown), and the ground connector 914 electrically connects the metal frame 930 to a ground conductor 940. The conductive line 923 electrically connects the coupling element 925 to a front-end circuit (not shown), and the ground connector 924 electrically connects the coupling element 925 to a ground plane, in this example, the ground conductor 940. The coupling element 925 may be, as in this example, disposed and configured to capacitively couple to the metal frame 930. The conductive line 933 electrically connects the coupling element 935 to a front-end circuit (not shown), and the ground connector 934 electrically connects the coupling element 935 to a ground plane, in this example, the ground conductor 940. The coupling element 935 may be, as in this example, disposed and configured to capacitively couple to the metal frame 930.

Still other implementations may be used. For example, an implementation may include antenna systems similar to the antenna systems 410, 420 but disposed at a bottom of a UE instead of at a top of a UE (e.g., as shown in FIG. 4) or disposed along more than two edges. Different portions of a UE may present different electrical environments and/or different mechanical challenges for placing antenna systems. As another example, an implementation may include antenna systems similar to the antenna systems 410, 420 but disposed along the same edge (e.g., a side edge) of a UE instead of along different edges of a UE as shown in FIG. 4. Still other implementations are possible.

Antenna systems of various implementations may be used for a variety of purposes and may be used in a variety of frequency bands. Various implementation may have one or more better performance characteristics relative to other antenna system configurations and/or may have a better phone space usage factor than other antenna system configurations. For example, implementations may provide improvements relative to a prior design like the apparatus 400 shown in FIG. 4, but with both of the antenna systems configured like the antenna system 410 (with direct electrical connections from the FEC and the ground to the metal frame), or with an apparatus with antenna systems disposed like the antenna systems 310, 330 shown in FIG. 3 with both of the antenna systems configured like the antenna system 410. These prior designs may be used for LB and GNSS signaling, have phone space usage factors of about 50% and 25%, respectively, and have bandwidths of about 0.8 GHz. Implementations discussed herein may provide one or more improvements thereto. For example, the antenna system 410 may be used for LB (Low Band) and JPB (Japan Band) signaling, the antenna system 420 may be used for GNSS signaling, the combination may have a phone space usage factor of about 25%, and a bandwidth (of LB, JPB, and GNSS) of about 0.9 GHz. As another example, with a configuration similar to the apparatus 400 but with the antenna systems 410, 420 disposed at a bottom of the apparatus, the antenna system 410 may be used for LB signaling and the antenna system 420 for GNSS signaling, the combination may have a phone space usage factor of about 25%, and a bandwidth of about 0.8 GHz. As another example, the antenna system 510 may be used for MHB (Middle High Band) signaling, the antenna system 520 may be used for sub-6 GHz signaling, the combination may have a phone space usage factor of about 12%, and a bandwidth of about 3.7 GHz. As another example, the antenna system 610 may be used for LMHB (Low Middle High Band) signaling, the antenna system 620 may be used for GNSS signaling, the antenna system 630 may be used for sub-6 GHz signaling, the combination may have a phone space usage factor of about 12%, and a bandwidth of about 3.7 GHz. The LB frequencies include B71, B12, B28, B20, B5, B8, etc. The JPB frequencies include B11, B21, B32. The GNSS frequencies include L1, L2, L5. The MHB frequencies include B1, B2, B3, B7, B40, B41, etc. The sub-6 GHz frequencies include N77, N78, N79. The LMHB frequencies includes B1, B2, B3, B5, B7, B8, B12, B20, B28, B40, B41, etc.

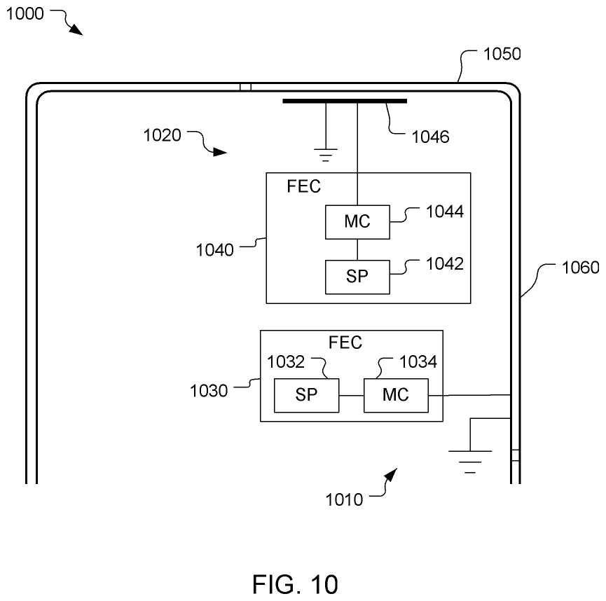

Referring to FIG. 10, with further reference to FIG. 4, an apparatus 1000 is an example of the apparatus 400 and includes antenna systems 1010, 1020 that are configured similarly to the antenna systems 410, 420. The antenna systems 1010, 1020 include FECs 1030, 1040, respectively, that include signal processing modules 1032, 1042 and matching circuits 1034, 1044, respectively. The matching circuits 1034, 1044 provide independent matching impedances for the different antenna systems 1010, 1020, and thus present separate impedances to the radiator (e.g., a portion 1050 of a metal frame 1060 of the apparatus 1000) used for the antenna systems 1010, 1020. The separate matching circuits 1034, 1044 may be customized for the respective antenna systems 1010, 1020 to provide good return loss (e.g., better than 5 dB, better than 10 dB, or more) at the frequencies of operation of the antenna systems 1010, 1020, and good isolation (e.g., better than 5 dB, better than 10 dB, or more) between the antenna systems 1010, 1020. By having a coupling element 1046 that is reactively coupled, but not physically connected by an electrical conductor, to the metal frame 1060, the antenna systems 1010, 1020 are isolated from each other and can operate concurrently, each with acceptable performance (e.g., able to transmit signals effectively and/or able to receive and process (e.g., decode, measure, etc.) signals effectively).

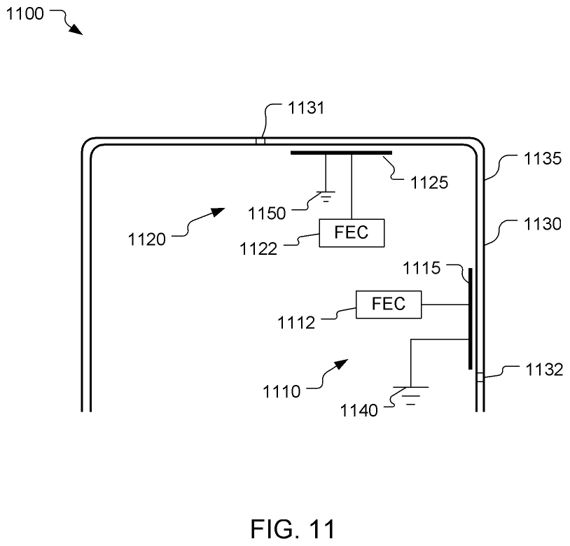

Referring to FIG. 11, with further reference to FIG. 4, an apparatus 1100 includes antenna systems 1110, 1120, that are examples of the antenna systems 310, 320. In this example, both of the antenna systems 1110, 1120 are configured similarly to the antenna system 420, including respective coupling elements 1115, 1125 that are configured and disposed to capacitively couple to a portion 1135 of a metal frame 1130 between breaks 1131, 1132. The coupling elements 1115, 1125 are electrically connected to FECs 1112, 1122 and to grounds 1140, 1150, respectively.

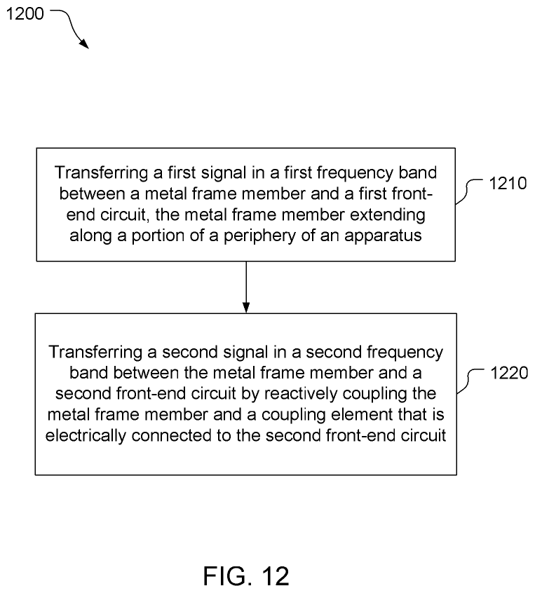

Referring to FIG. 12, with further reference to FIGS. 3-6, 10, and 11, a block flow diagram of a signal transfer method 1200 includes the stages shown. The method 1200 is, however, an example and not limiting. The method 1200 may be altered, e.g., by having one or more stages added, removed, rearranged, combined, performed concurrently, and/or having single stages split into multiple stages.

At stage 1210, the method 1200 includes transferring a first signal in a first frequency band between a metal frame member and a first front-end circuit, the metal frame member extending along a portion of a periphery of an apparatus. For example, one or more signals may be sent from the FEC 312 to the portion 370 of the metal frame 340 via the energy coupler 314 and/or one or more signals may be received by the FEC 312 from the portion 370 of the metal frame 340 via the energy coupler 314. The antenna system 310 (e.g., the FEC 312, the energy coupler 314, and the portion 370 of the metal frame 340) may comprise means for transferring the first signal between the metal frame member and the first front-end circuit.

At stage 1220, the method 1200 includes transferring a second signal in a second frequency band between the metal frame member and a second front-end circuit by reactively coupling the metal frame member and a coupling element that is electrically connected to the second front-end circuit. For example, one or more signals may be sent from the FEC 322 to the portion 370 of the metal frame 340 via the energy coupler 324 and/or one or more signals may be received by the FEC 322 from the portion 370 of the metal frame 340 via the energy coupler 324. The antenna system 320 (e.g., the FEC 322, the energy coupler 324, and the portion 370 of the metal frame 340) may comprise means for transferring the second signal between the metal frame member and the second front-end circuit.

Implementations of the method 1200 may include one or more of the following features. In an example implementation, transferring the second signal comprises capacitively coupling the metal frame member and the coupling element. For example, one or more signals may be sent from the FEC 422 to the portion 435 of the metal frame 430 via the conductive line 423 and the coupling element 425 (that is capacitively coupled to the metal frame 430) and/or one or more signals may be received by the FEC 422 from the portion 435 of the metal frame 430 via the coupling element 425 and the conductive line 423. As another example, one or more signals may be sent from the FEC 522 to the metal frame 530 via the conductive line 523 and the coupling element 525 (that is capacitively coupled to the metal frame 530) and/or one or more signals may be received by the FEC 522 from the metal frame 530 via the coupling element 525 and the conductive line 523. As another example, one or more signals may be sent from the FEC 622 to the metal frame 670 via the conductive line 623 and the coupling element 625 (that is capacitively coupled to the metal frame 670) and/or one or more signals may be received by the FEC 622 from the metal frame 670 via the coupling element 625 and the conductive line 623. The coupling elements 425, 525, 625 and the metal frames 430, 530, 670, respectively, may comprise means for capacitively coupling the metal frame member and the coupling element.

Also or alternatively, implementations of the method 1200 may include one or more of the following features. In an example implementation, transferring the first signal comprises transferring the first signal through an electrical connection between the metal frame member and the first front-end circuit. For example, one or more signals may be sent from the FEC 412 to the portion 435 of the metal frame 430 via the conductive line 413 and/or one or more signals may be received by the FEC 412 from the portion 435 of the metal frame 430 via the conductive line 413. The conductive line 413 may comprise means for transferring the first signal through an electrical connection. In another example implementation, the coupling element is a first coupling element, and transferring the first signal comprises capacitively coupling the metal frame member and a second coupling element that is electrically connected to the first front-end circuit. For example, the first coupling element may be the coupling element 1125 and one or more signals may be sent from the FEC 1112 to the portion 1135 of the metal frame 1130 via the coupling element 1115 (that is capacitively coupled to the metal frame 1130) and a conductive line and/or one or more signals may be received by the FEC 1112 from the portion 1135 of the metal frame 1130 via the coupling element 1115 and the conductive line. The coupling element 1115 and the metal frame 1130 may comprise means for capacitively coupling the second coupling element and the metal frame member. As another example, the first coupling element may be the coupling element 625 and one or more signals may be sent from the FEC 632 to the metal frame 670 via the coupling element 635 (that is capacitively coupled to the metal frame 670) and the conductive line 633 and/or one or more signals may be received by the FEC 632 from the metal frame 670 via the coupling element 635 and the conductive line 633. The coupling element 635 and the metal frame 670 may comprise means for capacitively coupling the second coupling element and the metal frame member.

### Implementation Examples

Implementation examples are provided in the following numbered clauses.

Clause 1. An apparatus comprising:
a metal frame member extending along a portion of a periphery of the apparatus;
a first front-end circuit coupled to the metal frame member and configured to at least one of transmit a first signal in a first frequency band to the metal frame member or receive the first signal from the metal frame member;
a first ground connector coupled to the metal frame member, and physically and electrically connected to a first ground conductor;
a coupling element that is spaced apart from the metal frame member and is configured and disposed relative to the metal frame member to reactively couple to the metal frame member;
a second front-end circuit electrically connected to the coupling element and configured to at least one of transmit a second signal in a second frequency band to the coupling element or receive the second signal from the coupling element; and
a second ground connector electrically connected to the coupling element and physically and electrically connected to a second ground conductor.

Clause 2. The apparatus of claim 1, wherein the coupling element comprises an electrical conductor that is configured and disposed relative to the metal frame member to capacitively couple to the metal frame member.

Clause 3. The apparatus of claim 2, wherein the coupling element is separated from the metal frame member by less than 0.01 wavelengths of the second signal along a first portion of the metal frame member.

Clause 4. The apparatus of claim 3, wherein the coupling element is separated from the first portion of the metal frame member by less than 0.01 wavelengths of the second signal for a length between 0.1 wavelengths of the second signal and 0.2 wavelengths of the second signal.

Clause 5. The apparatus of claim 3, wherein the first front-end circuit is electrically connected to the first portion of the metal frame member.

Clause 6. The apparatus of claim 1, wherein the coupling element is a first coupling element, the apparatus further comprising:
a second coupling element that is spaced apart from a second portion of the metal frame member, separate from the first portion of the metal frame member, and is configured and disposed relative to the second portion of the metal frame member to reactively couple to the metal frame member;
a third front-end circuit electrically connected to the second coupling element and configured to process a third signal; and
a third ground connector electrically connected to the second coupling element and physically and electrically connected to a third ground conductor.

Clause 7. The apparatus of claim 1, wherein the first front-end circuit and the first ground connector are electrically connected to the metal frame member.

Clause 8. The apparatus of claim 7, further comprising:
a first energy coupler connector electrically connecting the first front-end circuit to the metal frame member; and
a second energy coupler connector, physically separate from the first energy coupler connector, electrically connecting the second front-end circuit to the coupling element;
wherein the first ground connector electrically connects the metal frame member to the first ground conductor; and
wherein the second ground connector is physically separate from the first ground connector and electrically connects the coupling element to the second ground conductor.

Clause 9. The apparatus of claim 1, wherein the first ground conductor is the second ground conductor.

Clause 10. The apparatus of claim 1, wherein the metal from member extends along at least portions of two different edges of the apparatus.

Clause 11. The apparatus of claim 1, wherein the first frequency band and the second frequency band are non-overlapping frequency bands, and wherein:
the first frequency band is a standardized first communication frequency band or a standardized first positioning frequency band, and
the second frequency band is a standardized second communication frequency band or a standardized second positioning frequency band.

Clause 12. The apparatus of claim 1, wherein the first front-end circuit comprises a first matching circuit that provides a first matching impedance and the second front-end circuit comprises a second matching circuit that provides a second matching impedance that is independent of the first matching impedance.

Clause 13. A signal transfer method comprising:
transferring a first signal in a first frequency band between a metal frame member and a first front-end circuit, the metal frame member extending along a portion of a periphery of an apparatus; and
transferring a second signal in a second frequency band between the metal frame member and a second front-end circuit by reactively coupling the metal frame member and a coupling element that is electrically connected to the second front-end circuit.

Clause 14. The signal transfer method of claim 13, wherein transferring the second signal comprises capacitively coupling the metal frame member and the coupling element.

Clause 15. The signal transfer method of claim 13, wherein transferring the first signal comprises transferring the first signal through an electrical connection between the metal frame member and the first front-end circuit.

Clause 16. The signal transfer method of claim 13, wherein the coupling element is a first coupling element, and wherein transferring the first signal comprises capacitively coupling the metal frame member and a second coupling element that is electrically connected to the first front-end circuit.

Clause 17. An apparatus comprising:
means for transferring a first signal in a first frequency band between a metal frame member and a first front-end circuit, the metal frame member extending along a portion of a periphery of an apparatus; and
means for transferring a second signal in a second frequency band between the metal frame member and a second front-end circuit by reactively coupling the metal frame member and a coupling element that is electrically connected to the second front-end circuit.

Clause 18. The apparatus of claim 17, wherein the means for transferring the second signal comprises means for capacitively coupling the metal frame member and the coupling element.

Clause 19. The apparatus of claim 17, wherein the means for transferring the first signal comprises means for transferring the first signal through an electrical connection between the metal frame member and the first front-end circuit.

Clause 20. The apparatus of claim 17, wherein the coupling element is a first coupling element, and wherein the means for transferring the first signal comprises means for capacitively coupling the metal frame member and a second coupling element that is electrically connected to the first front-end circuit.

### Other Considerations

Other examples and implementations are within the scope of the disclosure and appended claims. For example, configurations other than those shown may be used. Also, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices (also called wireless communications devices). A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or +0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or +0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. An apparatus comprising:
a metal frame member extending along a portion of a periphery of the apparatus;
a first front-end circuit coupled to the metal frame member and configured to at least one of transmit a first signal in a first frequency band to the metal frame member or receive the first signal from the metal frame member;
a first ground connector coupled to the metal frame member, and physically and electrically connected to a first ground conductor;
a coupling element that is spaced apart from the metal frame member and is configured and disposed relative to the metal frame member to reactively couple to the metal frame member;
a second front-end circuit electrically connected to the coupling element and configured to at least one of transmit a second signal in a second frequency band to the coupling element or receive the second signal from the coupling element; and
a second ground connector electrically connected to the coupling element and physically and electrically connected to a second ground conductor.

2. The apparatus of claim 1, wherein the coupling element comprises an electrical conductor that is configured and disposed relative to the metal frame member to capacitively couple to the metal frame member.

3. The apparatus of claim 2, wherein the coupling element is separated from the metal frame member by less than 0.01 wavelengths of the second signal along a first portion of the metal frame member.

4. The apparatus of claim 3, wherein the coupling element is separated from the first portion of the metal frame member by less than 0.01 wavelengths of the second signal for a length between 0.1 wavelengths of the second signal and 0.2 wavelengths of the second signal.

5. The apparatus of claim 3, wherein the first front-end circuit is electrically connected to the first portion of the metal frame member.

6. The apparatus of claim 1, wherein the coupling element is a first coupling element and is spaced apart from a first portion of the metal frame member to reactively couple to the first portion of the metal frame member, the apparatus further comprising:
a second coupling element that is spaced apart from a second portion of the metal frame member, separate from the first portion of the metal frame member, and is configured and disposed relative to the second portion of the metal frame member to reactively couple to the metal frame member;
a third front-end circuit electrically connected to the second coupling element and configured to process a third signal; and
a third ground connector electrically connected to the second coupling element and physically and electrically connected to a third ground conductor.

7. The apparatus of claim 1, wherein the first front-end circuit and the first ground connector are electrically connected to the metal frame member.

8. The apparatus of claim 7, further comprising:
a first energy coupler connector electrically connecting the first front-end circuit to the metal frame member; and
a second energy coupler connector, physically separate from the first energy coupler connector, electrically connecting the second front-end circuit to the coupling element;
wherein the first ground connector electrically connects the metal frame member to the first ground conductor; and
wherein the second ground connector is physically separate from the first ground connector and electrically connects the coupling element to the second ground conductor.

9. The apparatus of claim 1, wherein the first ground conductor is the second ground conductor.

10. The apparatus of claim 1, wherein the metal frame member extends along at least portions of two different edges of the apparatus.

11. The apparatus of claim 1, wherein the first frequency band and the second frequency band are non-overlapping frequency bands, and wherein:
the first frequency band is a standardized first communication frequency band or a standardized first positioning frequency band, and
the second frequency band is a standardized second communication frequency band or a standardized second positioning frequency band.

12. The apparatus of claim 1, wherein the first front-end circuit comprises a first matching circuit that provides a first matching impedance and the second front-end circuit comprises a second matching circuit that provides a second matching impedance that is independent of the first matching impedance.

13. A signal transfer method comprising:
transferring a first signal in a first frequency band between a metal frame member and a first front-end circuit, the metal frame member extending along a portion of a periphery of an apparatus; and
transferring a second signal in a second frequency band between the metal frame member and a second front-end circuit by reactively coupling the metal frame member and a coupling element that is electrically connected to the second front-end circuit.

14. The signal transfer method of claim 13, wherein transferring the second signal comprises capacitively coupling the metal frame member and the coupling element.

15. The signal transfer method of claim 13, wherein transferring the first signal comprises transferring the first signal through an electrical connection between the metal frame member and the first front-end circuit.

16. The signal transfer method of claim 13, wherein the coupling element is a first coupling element, and wherein transferring the first signal comprises capacitively coupling the metal frame member and a second coupling element that is electrically connected to the first front-end circuit.

17. An apparatus comprising:
means for transferring a first signal in a first frequency band between a metal frame member and a first front-end circuit, the metal frame member extending along a portion of a periphery of the apparatus; and
means for transferring a second signal in a second frequency band between the metal frame member and a second front-end circuit by reactively coupling the metal frame member and a coupling element that is electrically connected to the second front-end circuit.

18. The apparatus of claim 17, wherein the means for transferring the second signal comprises means for capacitively coupling the metal frame member and the coupling element.

19. The apparatus of claim 17, wherein the means for transferring the first signal comprises means for transferring the first signal through an electrical connection between the metal frame member and the first front-end circuit.

20. The apparatus of claim 17, wherein the coupling element is a first coupling element, and wherein the means for transferring the first signal comprises means for capacitively coupling the metal frame member and a second coupling element that is electrically connected to the first front-end circuit.
